(19) United States
(12) Patent Application Publication
(10) Pub. No.: US 2017/0031558 A1
(43) Pub. Date: Feb. 2, 2017

(54) Device and System for Interactive Touch Capacitive Movable Platform with One or More Viewing Apertures for Capacitive Touch Screens

(71) Applicants: Fredric ELLMAN, Tarrytown, NY (US); Steven ELLMAN, Brooklyn, NY (US)

(72) Inventors: Fredric ELLMAN, Tarrytown, NY (US); Steven ELLMAN, Brooklyn, NY (US)

(21) Appl. No.: 15/220,783

(22) Filed: Jul. 27, 2016

Related U.S. Application Data
(60) Provisional application No. 62/197,604, filed on Jul. 28, 2015.

(51) Int. Cl. G06F 3/0488; G06T 13/80

(52) U.S. Cl. CPC G06F 3/0488; G06T 13/80; G06T 2200/24

(57) ABSTRACT

A toy device for interacting with a touch sensitive screen of an electronic device to initiate a graphical image, includes a platform with first and second surfaces and a viewing aperture. A plurality of touch sensitive sections are provided on one of the first and second surfaces for interaction by a user, and a plurality of touch sensitive sections are provided on the other of the first and second surfaces for interaction with the touch sensitive screen to initiate a graphical image for viewing by the user through the aperture.

### CROSS-REFERENCE TO RELATED APPLICATIONS

The present application claims priority on prior U.S. Provisional Patent Application Ser. No. 62/197,604, filed Jul. 28, 2015, which is hereby incorporated herein in its entirety by reference.

### FIELD AND BACKGROUND OF THE INVENTION

The present invention is in the field of touch capacitive interface devices for touch sensitive screens, such as those on a tablet device or on a smart phone.

Currently, touch sensitive capacitive interface devices such as various stylus pens and three dimensional figures provide a means for interacting with a capacitive touch screen. As these devices are generally solid or opaque, they do not provide a means for viewing the graphics on the touch screen through the interface device itself, and therefore do not allow for a practical means to view and interact with the graphics in the aperture viewing area, as utilized with specific computer programming in the tablet or smart phone.

### SUMMARY OF THE INVENTION

The present invention is a system utilizing one or more of the following features:
A platform that has a plurality of touch sensitive capacitive sections that react with a person's fingers and with a touch sensitive capacitive screen.
One or more apertures that allow the graphics on the screen to be viewed through the apertures in the platform.
Specific computer programming for a tablet, smart phone device, or any touch sensitive screen. The specific programming allows for the creation of graphical images that appear within the confines of the aperture viewing area on the touch screen. The graphical images that appear can be programmed to be non-moving or animated graphical images.
The specific graphical images that appear within the confines of the aperture on the platform are allowed to be initiated by the program, when a person touches the capacitive sections on the platform. Therefore, touching the screen directly, without touching the capacitive sections on the platform will not initiate the program to produce the specific graphical images in the aperture.
Varying the placement of the touch sensitive sections in the platform allow for corresponding dedicated various graphical images to appear in the aperture in the platform, as created by the program.
The apertures in the platforms can be of various sizes and shapes and function in accordance with the specific corresponding placement of the touch sensitive sections on the platform. The computer program can read the placements of the touch sensitive sections on any individual platform and produce a graphical image that corresponds in size and shape with the size and shape of the aperture in the platform.
The platforms themselves can be of an infinite variety of sizes and shapes, such as to be used as jewelry, ornaments, toys, etc.
The invention in its present embodiment can be utilized in many applications, such as in apps that are downloaded into touch sensitive screen devices. The downloaded apps can be in the form of books, comic books, maps and graphic images of unlimited design that the user can interact with using this system.

### BRIEF DESCRIPTION OF THE DRAWINGS

One of the aspects, novel features and advantages of the present invention will become apparent from the following detailed description of a preferred embodiment(s) of the invention, as illustrated in the drawings, in which:

FIG. 1 is a drawing of a platform in accordance with a preferred embodiment of the invention, showing the capacitive touch areas and an aperture;

FIG. 2 is a drawing of fingers touching the capacitive touch areas;

FIG. 3 is a drawing of the device on a capacitive touch screen. There are no fingers touching the device and no image in aperture in this case;

FIG. 4 is a drawing of a close up of the device on a capacitive touch screen. In this case there are fingers on each capacitive touch section on the platform and an image appears in the aperture on the screen;

FIG. 5 is a drawing of three platforms with three examples of capacitive section placements;

FIG. 6 is a drawing of examples of possible configurations of platform shapes, aperture shapes and capacitive touch sections placement; and

FIG. 7 is a drawing of a possible animation sequence on the screen as seen through the aperture in the platform. The scenes on the screen are activated by touching the capacitive sections of the platform.

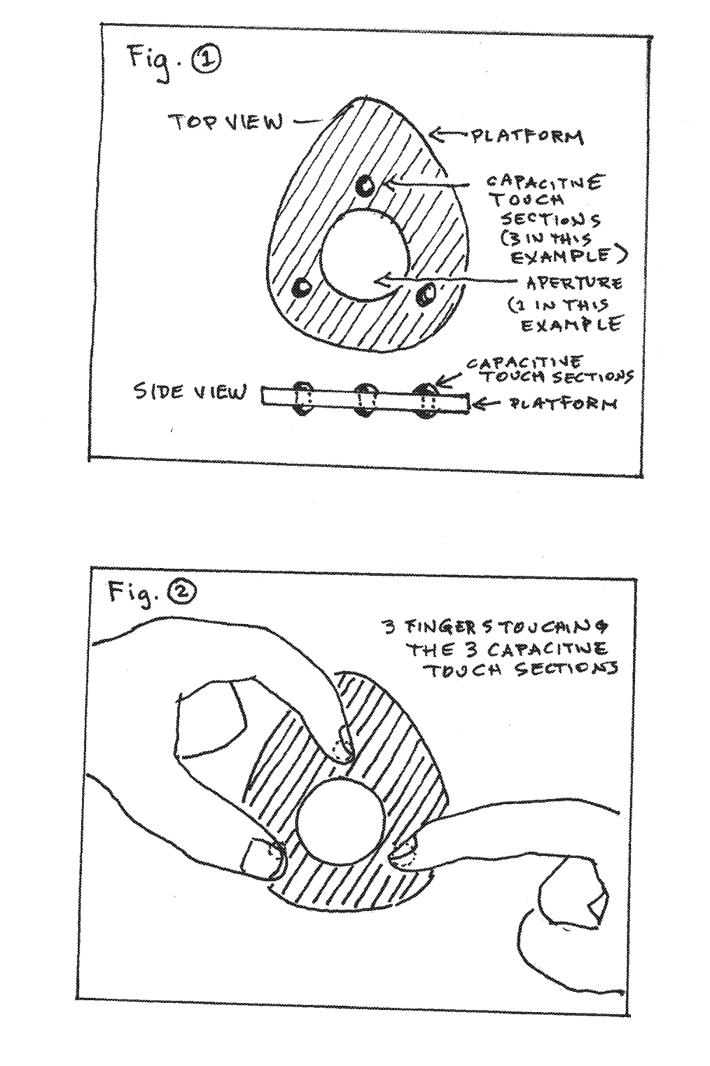

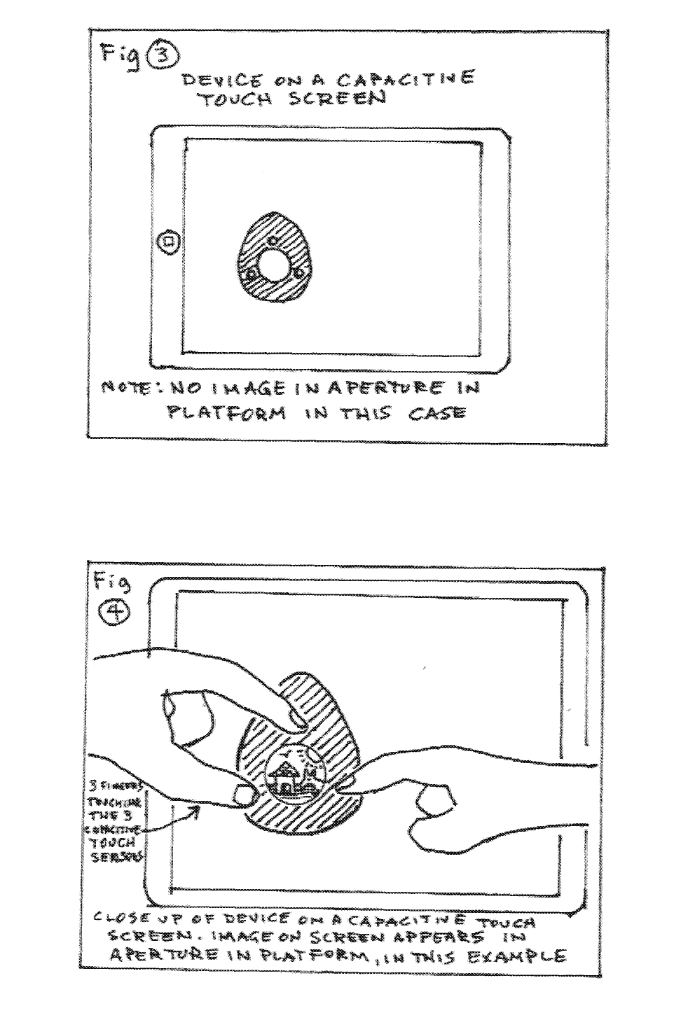

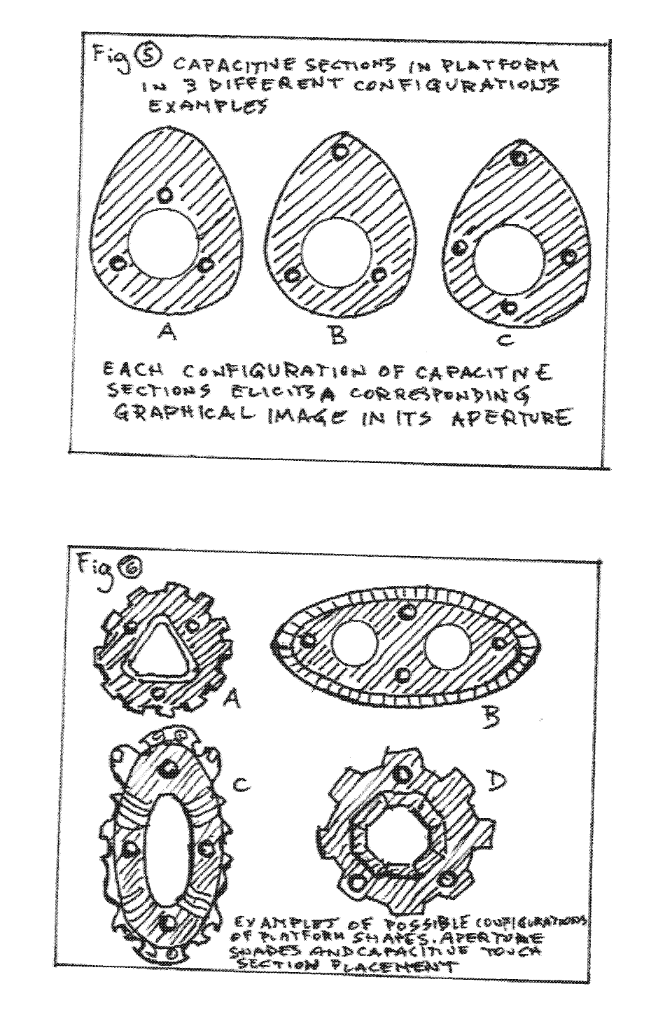

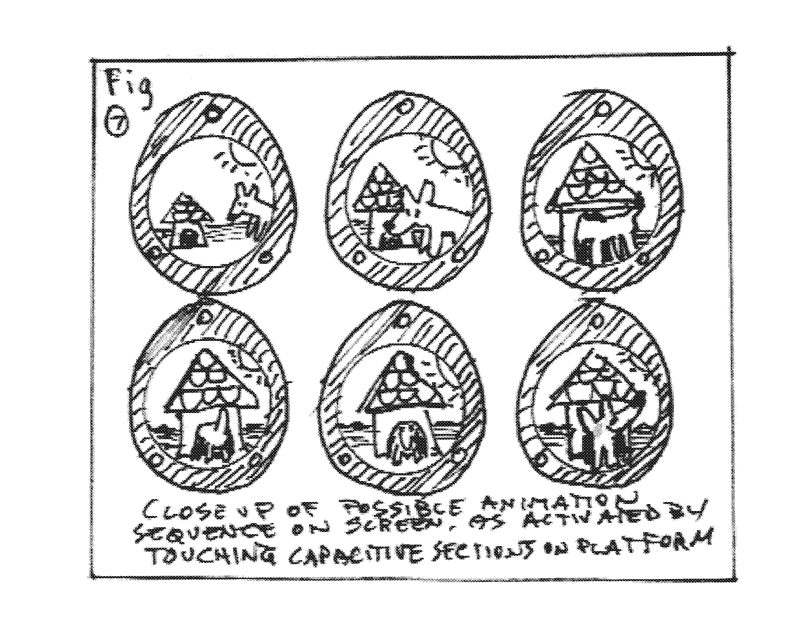

### DETAILED DESCRIPTION OF THE PREFERRED EMBODIMENT(S) OF THE PRESENT INVENTION

The present invention is directed to a system, preferably including a touch sensitive platform with one or more viewing apertures and a corresponding computer program that works with capacitive touch screen devices, creating the images that appear with in the viewing aperture(s) in the platform. The capacitive touch screen device, such as a tablet or smart phone, can have an app program downloaded into it that will allow the device to be interactive with the touch sensitive platform.

To activate and utilize the system, the touch sensitive platform is placed on a touch sensitive screen device. The touch sensitive platform has sections that respond to the user's touch capacitance on its top side and convey the capacitance of the user through the platform to specific areas on its bottom side. The touch sensitive areas can be constructed using various shapes and from various materials, such as in a plated surface. The user then touches the touch sensitive areas on the top side of the platform. The touch sensitive screen device can then detect the platform's bottom side capacitance areas when activated and convey this information to the corresponding computer program. Once activated, the computer program creates an image that appears in the one or more viewing apertures in the platform.

The computer program also detects and correlates the specific placement of the capacitance areas on the bottom side of the platform. This allows for the computer program to dedicate specific programs to individual platforms.

The computer program also detects whether the activated platform is stationary or being moved by the user. This allows for the images that appear in the aperture to stay centered in the aperture(s) in the platform. Also, when the activated platform is rotated on the screen, the images correspondingly rotate in its aperture(s).

The computer program can also detect the speed at which the platform is being moved and have corresponding images that are associated with the different speeds of platform movement.

When the activated platform is placed on or moved to different specific graphic display areas on the screen created by the computer program, the computer program can initiate new images in the aperture and elsewhere on the display screen. Corresponding sounds coming from the computer program can also be initiated in synchronization with the images.

The computer program can also be programmable and programmed by the user. This allows for many interactive scenarios, such as the creation of customized images that appear in the user's platform(s).

It should be understood that numerous variations are possible, while adhering to the inventive concept. Such variations are contemplated as being a part of the present invention.

While only a limited number of preferred embodiments of the present invention have been disclosed for purposes of illustration, it is obvious that many modifications and variations could be made thereto.

While this invention has been described as having preferred sequences, ranges, ratios, steps, order of steps, materials, structures, symbols, indicia, graphics, color scheme(s), shapes, configurations, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the claims appended hereto or presented later. The invention, therefore, is not limited to the preferred embodiment(s) shown/described herein.

What is claimed is:

1. A toy device for interacting with a touch sensitive screen of an electronic device to initiate a graphical image, comprising:
a) a platform including first and second surfaces;
b) said platform including a viewing aperture;
c) a plurality of touch sensitive sections on one of said first and second surfaces for interaction by a user; and
d) a plurality of touch sensitive sections on the other of said first and second surfaces for interaction with the touch sensitive screen to initiate a graphical image for viewing by the user through said aperture.

2. The toy device of claim 1, wherein:
a) said viewing aperture is of varying size and/or shape.

3. The toy device of claim 1, wherein:
a) said platform includes a plurality of said viewing apertures.

4. The toy device of claim 1, wherein:
a) said platform is of varying size and/or shape.

5. The toy device of claim 1, wherein:
a) the initiated graphical image is animated.

6. The toy device of claim 1, wherein:
a) the initiated graphical image is non-animated.
